(19) United States
(12) Patent Application Publication
(10) Pub. No.: US 2024/0049118 A1
(43) Pub. Date: Feb. 8, 2024

(54) Method and Apparatus Related to Cell Searching in Non-Terrestrial Networks

(71) Applicant: Nokia Technologies Oy, Espoo (FI)

(72) Inventors: Rafhael Medeiros De Amorim, Aalborg (DK); Istvan Zsolt Kovacs, Aalborg (DK); Anthony Lo, Bristol (GB)

(21) Appl. No.: 18/229,448

(22) Filed: Aug. 2, 2023

(30) Foreign Application Priority Data
Aug. 8, 2022 (GB) 2211523.2

(51) Int. Cl. H04W 48/16; H04B 7/185

(52) U.S. Cl. CPC H04W 48/16; H04B 7/18513

(57) ABSTRACT

A technique including: determining at a user equipment that a current non-terrestrial cell belonging to a network has become unavailable to the user equipment; and determining whether to initiate a cell search based on at least information at the user equipment about timing of availability to the user equipment of one or more other non-terrestrial cells belonging to the network.

### TECHNICAL FIELD

Example embodiments relate to apparatus, methods and computer programs related to cell searching in non-terrestrial networks.

### BACKGROUND

Searching at a user equipment (UE) for a new non-terrestrial network (NTN) cell to camp on may happen at a time after a cell on which the UE is currently camped is determined by the UE to no longer meet one or more criteria for selecting a cell to camp on.

### SUMMARY

A method, comprising: determining at a user equipment that a current non-terrestrial cell belonging to a network has become unavailable to the user equipment; and determining whether to initiate a cell search based on at least information at the user equipment about timing of availability to the user equipment of one or more other non-terrestrial cells belonging to the network.

Determining that the current cell has become unavailable to the user equipment may comprise determining that a service time has been reached after a determination at the user equipment that measurements by the user equipment of the current cell do not meet one or more cell selection criteria.

The method may comprise: in the event that the information indicates that one or more other non-terrestrial cells belonging to the network are to become available to the user equipment before a maximum waiting time after the service time: determining at the user equipment not to initiate a cell search before one or more of the one or more other cells of the non-terrestrial network becomes available according to the information at the user equipment.

Determining whether to initiate a cell search may comprise: starting a timer in response to determining that the current cell has become unavailable to the user equipment; determining that the information at the user equipment indicates that a non-terrestrial cell belonging to the network is not available to the user equipment before expiry of the timer; and initiating a cell search in response to expiry of the timer.

The timer may have a value hard-coded into the user equipment.

The timer may have a value based on information received via the current cell.

The timer may have a value dependent on one or more parameters of the user equipment.

The one or more parameters may comprise one of more of: a combined uplink performance capability and downlink performance capability of the user equipment, or battery settings of the user equipment, or battery condition of the user equipment.

The information may be received at the user equipment via the current cell.

The information may be based on measurements and calculations at the user equipment.

The information may be based on orbital information about satellites operating non-terrestrial cells.

The network may be a home public land mobile network for the user equipment.

A method, comprising: sending, to a user equipment served by a non-terrestrial cell belonging to a network, information about timing of availability to the user equipment of one or more other non-terrestrial cells belonging to the network.

The method may comprise: sending to the user equipment an indication of a maximum waiting time by which the user equipment is to initiate a cell search.

Apparatus, comprising means for: determining at a user equipment that a current non-terrestrial cell belonging to a network has become unavailable to the user equipment; and determining whether to initiate a cell search based on at least information at the user equipment about timing of availability to the user equipment of one or more other non-terrestrial cells belonging to the network.

Determining that the current cell has become unavailable to the user equipment may comprise determining that a service time has been reached after a determination at the user equipment that measurements by the user equipment of the current cell do not meet one or more cell selection criteria.

The apparatus may comprise means for: in the event that the information indicates that one or more other non-terrestrial cells belonging to the network are to become available to the user equipment before a maximum waiting time after the service time: determining at the user equipment not to initiate a cell search and not before one or more of the one or more other cells of the non-terrestrial network becomes available according to the information at the user equipment.

Determining whether to initiate a cell search may comprise: starting a timer in response to determining that the current cell has become unavailable to the user equipment; determining that the information at the user equipment indicates that a non-terrestrial cell belonging to the network is not available to the user equipment before expiry of the timer; and initiating a cell search in response to expiry of the timer.

The timer may have a value hard-coded into the user equipment.

The timer may have a value based on information received via the current cell.

The timer may have a value dependent on one or more parameters of the user equipment.

The one or more parameters may comprise one of more of: a combined uplink performance capability and downlink performance capability of the user equipment, or battery settings of the user equipment, or battery condition of the user equipment.

The information may be received at the user equipment via the current cell.

The information may be based on measurements and calculations at the user equipment.

The information may be based on orbital information about satellites operating non-terrestrial cells.

The network may be a home public land mobile network for the user equipment.

Apparatus, comprising: means for sending, to a user equipment served by a non-terrestrial cell belonging to a network, information about timing of availability to the user equipment of one or more other non-terrestrial cells belonging to the network.

The apparatus may comprise: means for sending to the user equipment an indication of a maximum waiting time by which the user equipment is to initiate a cell search.

Apparatus comprising: at least one processor; and at least one memory including computer program code, the at least one memory and computer program code configured to, with the at least one processor, cause the radio access node to perform: determining at a user equipment that a current non-terrestrial cell belonging to a network has become unavailable to the user equipment; and determining whether to initiate a cell search based on at least information at the user equipment about timing of availability to the user equipment of one or more other non-terrestrial cells belonging to the network.

Determining that the current cell has become unavailable to the user equipment may comprise determining that a service time has been reached after a determination at the user equipment that measurements by the user equipment of the current cell do not meet one or more cell selection criteria.

The at least one memory and computer program code may be configured to, with the at least one processor, cause the radio access node to: in the event that the information indicates that one or more other non-terrestrial cells belonging to the network are to become available to the user equipment before a maximum waiting time after the service time: determine at the user equipment not to initiate a cell search before one or more of the one or more other cells of the non-terrestrial network becomes available according to the information at the user equipment.

Determining whether to initiate a cell search may comprise: starting a timer in response to determining that the current cell has become unavailable to the user equipment; determining that the information at the user equipment indicates that a non-terrestrial cell belonging to the network is not available to the user equipment before expiry of the timer; and initiating a cell search in response to expiry of the timer.

The timer may have a value hard-coded into the user equipment.

The timer may have a value based on information received via the current cell.

The timer may have a value dependent on one or more parameters of the user equipment.

The one or more parameters may comprise one of more of: a combined uplink performance capability and downlink performance capability of the user equipment, or battery settings of the user equipment, or battery condition of the user equipment.

The information may be received at the user equipment via the current cell.

The information may be based on measurements and calculations at the user equipment.

The information may be based on orbital information about satellites operating non-terrestrial cells.

The network may be a home public land mobile network for the user equipment.

Apparatus comprising: at least one processor; and at least one memory including computer program code, the at least one memory and computer program code configured to, with the at least one processor, cause the radio access node to perform: sending, to a user equipment served by a non-terrestrial cell belonging to a network, information about timing of availability to the user equipment of one or more other non-terrestrial cells belonging to the network.

The at least one memory and computer program code may be configured to, with the at least one processor, cause the radio access node to: send to the user equipment an indication of a maximum waiting time by which the user equipment is to initiate a cell search.

Apparatus, comprising: determining circuitry for determining at a user equipment that a current non-terrestrial cell belonging to a network has become unavailable to the user equipment, and for determining whether to initiate a cell search based on at least information at the user equipment about timing of availability to the user equipment of one or more other non-terrestrial cells belonging to the network.

Apparatus, comprising: sending circuitry for sending to a user equipment served by a non-terrestrial cell belonging to a network, information about timing of availability to the user equipment of one or more other non-terrestrial cells belonging to the network.

A computer readable medium comprising program instructions stored thereon for performing: determining at a user equipment that a current non-terrestrial cell belonging to a network has become unavailable to the user equipment; and determining whether to initiate a cell search based on at least information at the user equipment about timing of availability to the user equipment of one or more other non-terrestrial cells belonging to the network.

A computer readable medium comprising program instructions stored thereon for performing: sending, to a user equipment served by a non-terrestrial cell belonging to a network, information about timing of availability to the user equipment of one or more other non-terrestrial cells belonging to the network.

A non-transitory computer readable medium comprising program instructions stored thereon for performing: determining at a user equipment that a current non-terrestrial cell belonging to a network has become unavailable to the user equipment; and determining whether to initiate a cell search based on at least information at the user equipment about timing of availability to the user equipment of one or more other non-terrestrial cells belonging to the network.

A non-transitory computer readable medium comprising program instructions stored thereon for performing: comprising: sending, to a user equipment served by a non-terrestrial cell belonging to a network, information about timing of availability to the user equipment of one or more other non-terrestrial cells belonging to the network.

A computer program comprising computer executable code which when run on at least one processor is configured to cause a user equipment at least to: determine at a user equipment that a current non-terrestrial cell belonging to a network has become unavailable to the user equipment; and determine whether to initiate a cell search based on at least information at the user equipment about timing of availability to the user equipment of one or more other non-terrestrial cells belonging to the network.

A computer program comprising computer executable code which when run on at least one processor is configured to cause a user equipment at least to: send to a user equipment served by a non-terrestrial cell belonging to a network, information about timing of availability to the user equipment of one or more other non-terrestrial cells belonging to the network.

In the above, many different aspects have been described. It should be appreciated that further aspects may be provided by the combination of any two or more of the aspects described above.

Various other aspects are also described in the following detailed description and in the attached claims.

### BRIEF DESCRIPTION OF THE FIGURES

Some example embodiments will now be described in further detail, by way of example only, with reference to the following examples and accompanying drawings, in which:

FIG. 1 shows a representation of an example of an architecture to which embodiments may be applied;

FIG. 2 shows a representation of an example of a constellation of low earth orbiting satellites providing coverage for a user equipment, according to some example embodiments;

FIG. 3 shows a representation of an example of operations of a user equipment in the architecture of FIG. 1, according to example embodiments;

FIG. 4 shows a representation of an example of three outcomes of the operations of FIG. 3;

FIG. 5 shows a representation of an example of apparatus for implementing the user equipment functionality of the user equipment of the architecture of FIG. 1 according to some example embodiments;

FIG. 6 shows a representation of an example of apparatus for implementing the gNB of the architecture of FIG. 1 according to some example embodiments; and

FIG. 7 shows a representation of an example of non-volatile memory media.

### DETAILED DESCRIPTION

By way of example, the following description focusses on the example of transmissions between a user equipment (UE) and an access network (AN) operating according to 3GPP 5G technology, but the underlying technique may also be applicable to transmissions between user equipment and access network operating according to other radio access technologies, such as more evolved or advanced 3GPP technologies, namely 5G-Advanced and 6G.

In example embodiments, the user equipment may be any device, apparatus or component implementing at least 3GPP user equipment (UE) functionality.

The UE may be a mobile or static device (e.g. a portable or non-portable computing device) including, but not limited to, the following types of devices: mobile phone, smartphone, personal digital assistant (PDA), handset, device using a wireless modem (alarm or measurement device, etc.), laptop and/or touch screen computer, tablet, game console, notebook, and multimedia device. It should be appreciated that a UE device may also be a nearly exclusive uplink only device, of which an example is a camera or video camera loading images or video clips to a network. A UE device may also be a device having capability to operate in Internet of Things (IoT) network which is a scenario in which objects are provided with the ability to transfer data over a network without requiring human-to-human or human-to-computer interaction, e.g. to be used in smart power grids and connected vehicles. The device may also utilise cloud. In some applications, a UE device may comprise a user portable device with radio parts (such as a watch, earphones or eyeglasses) and the computation is carried out in the cloud.

5G enables using multiple input-multiple output (MIMO) antennas, and may involve large numbers of base stations (gNBs) including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control). 5G may employ multiple frequency bands, e.g. below 6 GHz or above 24 GHz in the centimetre-wave (cmWave) and millimetre-wave (mmWave) frequency range, and may also be integrable with existing legacy radio access technologies, such as LTE. Integration with LTE may be implemented, as a system, where macro coverage is provided by LTE and radio interface access comes from small cells by aggregation to the LTE. In other words, may support both inter-RAT (inter-Radio Access Technologies) operability (such as LTE- and inter-RI operability (inter-radio interface operability, such as below 6 GHz-cmWave, 6 or above 24 GHz-cmWave and mmWave). 5G networks may employ network slicing, in which multiple independent and dedicated virtual sub-networks (network instances) may be created within the same infrastructure to run services that have different requirements on latency, reliability, throughput and mobility.

Low latency applications and services may be facilitated by bringing content close to the 5G system, which leads to local break out and multi-access edge computing (MEC). 5G enables analytics and knowledge generation to occur at the source of the data. This approach may involve leveraging resources that may not be continuously connected to a network such as laptops, smartphones, tablets and sensors. MEC provides a distributed computing environment for application and service hosting. MEC also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, Mobile Broadband, (MBB) or ensuring service availability for critical communications, and future railway/maritime/aeronautical communications. Satellite communication may utilise geostationary earth orbit (GEO) satellite systems, but also low earth orbit (LEO) satellite systems, in particular mega-constellations (systems in which hundreds of (nano)satellites are deployed). Each satellite in the mega-constellation may cover several satellite-enabled network entities that create on-ground cells. The on-ground cells may be created through an on-ground relay node or by a gNB located on-ground or in a satellite.

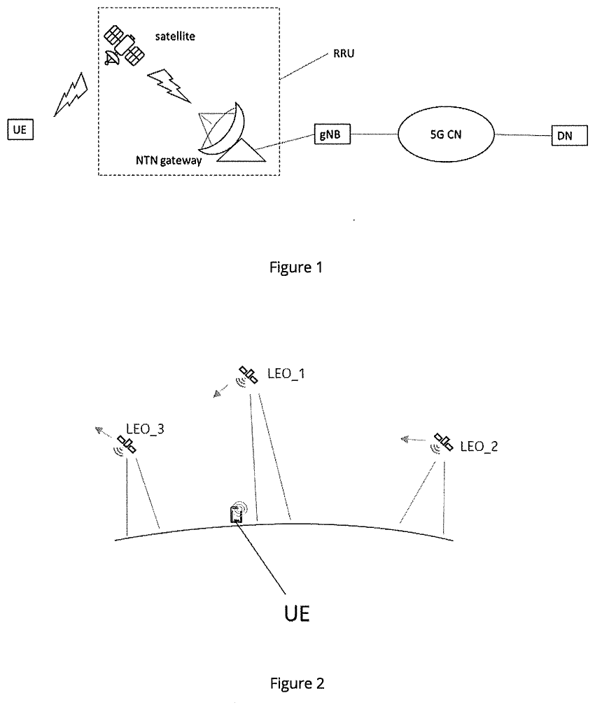

FIG. 1 shows an example of a 5G NR NTN architecture for a connection between a UE and a data network (DN) via a satellite, a NTN (Non-Terrestial Network) gateway, gNB, and 5G core network (5G CN). A public land mobile network (PLMN) may comprise terrestrial cells in addition to non-terrestrial cells.

This example architecture is a transparent satellite-based architecture of the kind described in 3GPP TR 38.821, in which the satellite payload implements frequency conversion and a radio frequency amplifier in both the uplink and downlink directions. The satellite and NTN gateway together function as a remote radio unit (RRU) for the gNB.

The satellites of a NTN may comprise low earth orbit (LEO) satellites, which move quickly in relation to a moving or stationary UE and the Earth; and a NTN may comprise a sparse constellation of LEO satellites. One consequence is that there may be gaps in the coverage provided by the NTN belonging to a PLMN. In the example shown in FIG. 2, LEO1, LEO2 and LEO3 are satellites operating NTN cells belonging to the same PLMN. UE was within the coverage of satellite LEO3, but orbital movement of the LEO3 has left UE outside the coverage of LEO3. Coverage for UE in the same PLMN is next provided by another satellite LEO1 of the NTN as orbital movement of LEO1 brings the coverage area of LEO1 into the location of UE. However, the switch from coverage for UE by LEO3 to coverage for UE by LEO1 may not be continuous, and there may be a gap of several minutes or even hours during which UE is not within the coverage of LEO1 or LEO3 or any other satellite belonging to the NTN for the same PLMN.

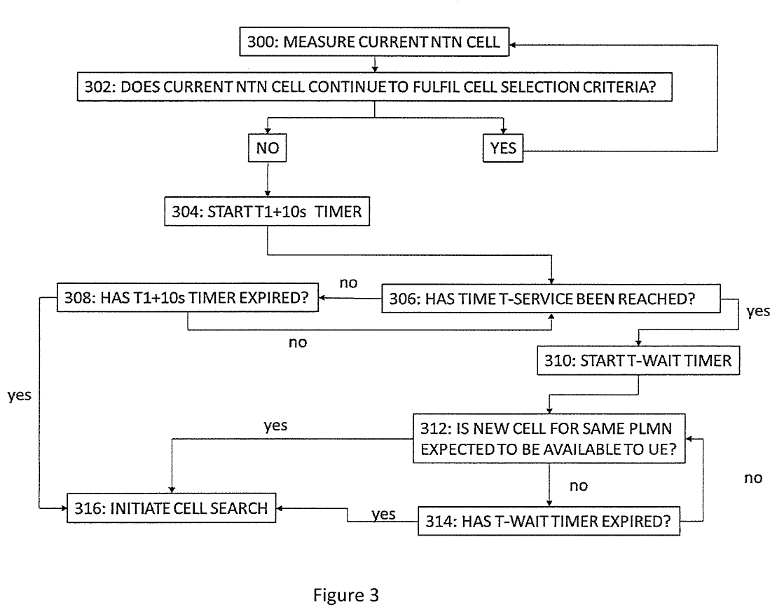

FIG. 3 shows a representation of an example of operations at UE in RRC (Radio Resource Control) idle mode camped on a NTN cell (current cell) belonging to a public land mobile network (PLMN) (e.g. the home PLMN (HPLMN) for UE).

UE periodically measures one or more parameters of one or more transmissions of the current cell (OPERATION 300).

UE determines whether the measurement results indicate that the current cell continues to fulfil one or more criteria for selecting a cell to camp on (OPERATION 302).

If the result of the determination is positive, UE continues with periodically measuring one or more parameters of transmissions of the current cell. On the other hand, if the result of the determination is negative (the instant of time at which such negative determination is made is referred to as T1), UE starts a 10 second timer (T1+10 s timer) (OPERATION 304).

UE monitors for whether a time at which UE is configured not to expect coverage from the current cell (referred to as time t-service) has been reached. For example, this may involve monitoring whether the UE clock has reached time t-service, or monitoring for expiry of a timer set to expire at time t-service (OPERATION 306). If time t-service has not been reached, UE monitors for expiry of the T1+10 s timer (OPERATION 308). If the T1+10 s timer has expired, UE proceeds to initiate a cell search procedure to search for a new cell to camp on (OPERATION 316). On the other hand, if the T1+10 s timer has not expired, UE returns to monitoring for whether time t-service has been reached (OPERATION 306).

In response to time t-service being reached, UE starts a maximum-waiting period timer (t-wait timer) (OPERATION 310).

UE has future availability information about the timing of next availability to the UE of one or more other NTN cells belonging to the same PLMN as the current cell on which the UE is camped (idle mode) or to which the UE is connected (connected mode). UE determines whether this future availability information indicates that a new NTN cell belonging to the same PLMN is now available to UE (OPERATION 312). In this example, the instant in time at a new NTN cell is expected to be available is referred to as t-cov, and UE determines whether the UE clock has reached t-cov. If the result of this determination is positive, UE proceeds to initiate a cell search procedure to search for a new cell to camp on (OPERATION 316). On the other hand, if the result of this determination is negative, UE monitors for expiry of the t-wait timer. If the t-wait timer has not expired, UE continues to determine whether the UE clock has reached t-cov (OPERATION 312). If the t-wait timer has expired, UE proceeds to initiate a cell search procedure to search for a new cell to camp on (OPERATION 316).

The time t-service indicates an instant in time before which the current cell is expected to remain available to the UE even after a determination at the UE that cell measurements at the UE indicate that the current cell no longer meets one or more cell selection criteria (criteria for selecting a cell for the UE to camp on). Time t-service is the time instant in the future that marks the transition from the current cell being expected to be available to the UE to the current cell being not expected to be available to the UE.

The duration of the t-wait timer may be hard coded into the UE. Alternatively, the duration of the t-wait timer may be configured by the network via the current cell. The duration of the t-wait timer may be calculated based on one or more parameters of the UE, including e.g. the UE-category of the UE (combined uplink performance capability and downlink performance capability of the user equipment), the battery settings of the UE, the battery condition of the UE.

In one example, the duration of the t-wait timer is configured such that the potential power saving at the UE justifies the additional time for which UE remains unregistered and not camped on any cell. For example, the duration of the t-wait timer may be as short as less than a minute, or may be as long as several hours. In some examples, the duration of the t-wait timer may be so long (effectively infinitely long) that UE will only initiate cell search after t-cov is reached (and there is expectancy of coverage by a NTN cell for the same PLMN), regardless of how long t-cov occurs after time t-service. For example, the UE may adopt such a long duration for the t-wait timer in an extended power saving situation, or when the UE is configured for mobile initiated connection only (which may require authorization via the current cell, before the current cell became unavailable).

There may be some events that trigger setting the duration of the t-wait timer to zero (or another non-zero value less than the normal, default value for the duration of the t-wait timer). For example, in the event that UE has data arriving in the buffer from higher layers at the UE, UE may initiate a cell search procedure in response to time t-service having been reached, to quickly find a cell via which to send the data in the buffer. Without any expectation of coverage by a NTN cell for the same PLMN, the cell search procedure may lead to UE landing on a different network (roaming), finding a different PLMN or a cell in a different frequency range.

In one example, the duration of the t-wait timer may be based on the discontinuous reception (DRX) setting most recently used at the UE. In one example, the duration of the t-wait timer may be set equal to the longest possible sleeping time of the DRX settings for the UE.

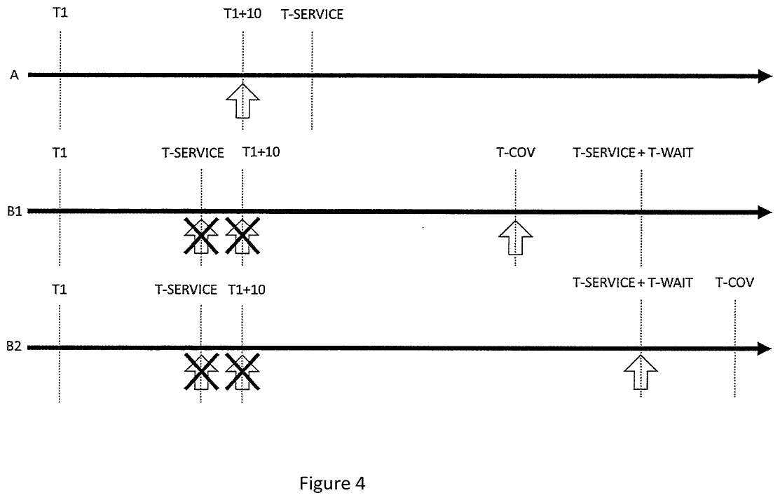

FIG. 4 is a time-sequence chart showing examples of three outcomes of the operations of FIG. 3. The thick arrows indicate points on the timeline when a cell search procedure is initiated, and the struckthrough thick arrows indicate that no cell search is initiated. T1 is the time at which UE determines that measurements of current cell transmissions indicate that the current cell no longer continues to meet one or more cell selection criteria for choosing a cell to camp on.

Outcome A: if time t-service occurs more than 10 seconds after T1, UE initiates a cell search procedure (as part of a cell selection procedure) in response to expiry of the T1+10 s timer. Before time t-service is reached, there is an expectation that the current cell is still available to the UE.

Outcome B1: if time t-service occurs less than 10 seconds after T1, and t-cov occurs before expiry of the t-wait timer, UE initiates a cell search procedure (as part of a cell selection procedure) before expiry of the t-wait timer. There is only a relatively short gap between loss of coverage for UE by the current NTN cell, and expected coverage for UE by a new NTN cell for the same PLMN (e.g. no more than several minutes). UE increases the chances of saving UE power and/or avoiding roaming charges by not initiating a cell search before t-cov.

Outcome B2: if time t-service occurs less than 10 seconds after T1, and the future availability information at UE indicates that one or more new NTN cells for the same PLMN are not available before expiry of the t-wait timer (i.e. t-cov occurs after expiry of the t-wait timer), UE initiates a cell search procedure (as part of a cell selection procedure) in response to expiry of the t-wait timer. When there is a relatively long gap (e.g. several hours) between loss of coverage for UE by the current NTN cell, and expected coverage for UE by a new NTN cell for the same PLMN; but after expiry of the t-wait timer, it is better that UE attempts to camp on a cell belonging to another PLMN, rather than remaining unregistered. Furthermore, after the elapse of a relatively long period of time after UE received information about t-cov or calculated t-cov, there is a greater chance that UE may have moved considerably into a location in which the t-cov value(s) stored at UE are no longer valid, and coverage by a NTN cell for the same PLMN may be available to UE sooner than the t-cov value(s) stored at UE indicate.

According to an example embodiment: UE in RRC_IDLE mode shall initiate a cell selection procedure for the selected PLMN when any of the following conditions is fulfilled:
(1) If the UE in RRC_IDLE has not found any new suitable cell based on searches and measurements using the intra-frequency, inter-frequency and inter-RAT information indicated in the system information within 10 s since time instance T1 provided that ‘t-Service’>(T1+10) seconds; or
(2) If the UE in RRC_IDLE has not found any new suitable cell based on searches and measurements using the intra-frequency, inter-frequency and inter-RAT information indicated in the system information until the time instance ‘t-Service’ and the UE is not configured with t-cov and t-wait; or
(3) If the UE is configured with t-cov and t-wait, and the UE in RRC_IDLE has not found any new suitable cell based on searches and measurements using the intra-frequency, inter-frequency and inter-RAT information indicated in the system information until (i) the time instance t-cov provided that t-cov is less than or equal to t-service+t-wait; or (ii) t-service+t-wait if t-cov>t-service+t-wait;
wherein T1 is the time instance in seconds when the UE has determined that the current cell no longer continues to fulfil the cell selection criterion; t-cov is the time instance in seconds where the UE expects coverage under the same PLMN arriving from a neighbour satellite; t-wait is a parameter that indicates the maximum acceptable duration of time for which UE may postpone starting searching for a new cell; and the system information is system information received via the current cell.

An indication of t-cov may be acquired by UE via the current cell. For example, the current cell may transmit information about the switch-on (coverage-on) time of a set of Earth fixed cells. Earth fixed cells are geographical areas fixed in location with respect to Earth. The current cell may calculate, based on the size of the current cell (coverage area of the satellite operating the current cell), the estimated time at which the centre of a new cell (centre of coverage area on Earth of another satellite) will have a significant overlap with the current coverage area on Earth of the current cell; and the current cell may broadcast an indication of the estimated time.

In one example, t-cov is calculated based on information about times at which other satellites are passing over the current location of the UE.

In one example, t-cov is measured/calculated by UE, and the measurements and/or calculations may be transparent to the network. For example, UE may estimate t-cov based on information received at the UE about the orbit of one or more satellites that will pass over the location of the UE.

The information stored at UE may include estimated coverage times (t-cov values) for more than one NTN satellite operating a cell belonging to the same PLMN. There may be more than one NTN satellite expected to provide coverage for UE before expiry of the t-wait timer. There may be more than one instance of t-cov before expiry of the t-wait timer. UE may choose any of these t-cov instances as the trigger to initial a cell search procedure.

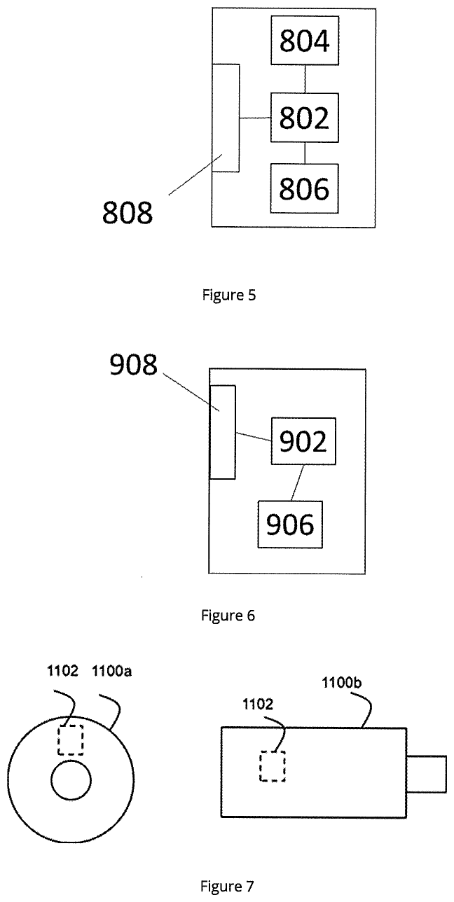

FIG. 5 illustrates an example of an apparatus for implementing UE functionality in the architecture of FIG. 1. The apparatus may include at least one processor 802 coupled to one or more interfaces 808. The one or more interfaces 808 may include one or more interfaces to e.g. other equipment/component(s) for which the UE functionality provides radio communications. The at least one processor 802 is also coupled to a radio unit 804 including one or more antennas etc. for making and receiving radio transmissions. The at least one processor 802 may also be coupled to at least one memory 806. The at least one processor 802 may be configured to execute an appropriate software code to perform the operations described above. The software code may be stored in the memory 806.

FIG. 6 illustrates an example of an apparatus for implementing the gNB in the architecture of FIG. 1. The apparatus may include at least one processor 902 coupled to one or more interfaces 908 for communication with at least the core network and the NTN gateway. The at least one processor 902 may also be coupled to at least one memory 906. The at least one processor 902 may be configured to execute an appropriate software code to perform the operations described above. The software code may be stored in the memory 906.

FIG. 7 shows a schematic representation of non-volatile memory media 1100a (e.g. computer disc (CD) or digital versatile disc (DVD)) and 1100b (e.g. universal serial bus (USB) memory stick) storing instructions and/or parameters 1102 which when executed by a processor allows the processor to perform one or more of the steps of the methods described previously.

It is to be noted that example embodiments may be implemented as circuitry, in software, hardware, application logic or a combination of software, hardware and application logic. In an example embodiment, the application logic, software or an instruction set is maintained on any computer program product or computer-readable medium. In the context of this document, a “computer-readable medium” may be any media or means that can contain, store, communicate, propagate or transport the instructions for use by or in connection with an instruction execution system, apparatus, or device, such as the radio access nodes or user equipment of the above-described example embodiments. The term “non-transitory” as used herein is a limitation of the medium itself (i.e. tangible, not a signal) as opposed to a limitation on data storage persistency (e.g. RAM vs ROM).

As used in this application, the term “circuitry” may refer to one or more or all of the following: (a) hardware-only circuit implementations (such as implementations in only analog and/or digital circuitry) and (b) combinations of hardware circuits and software (and/or firmware), such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as the user equipment or radio access nodes of the above-described embodiments, to perform various functions) and (c) hardware circuit(s) and/or processor(s), such as a microprocessor(s) or a portion of a microprocessor(s), that requires software (e.g. firmware) for operation, but the software may not be present when it is not needed for operation. This definition of ‘circuitry’ applies to all uses of this term in this application, including in any claims. As a further example, as used in this application, the term “circuitry” also covers an implementation of merely a hardware circuit or processor (or multiple processors) or portion of a hardware circuit or processor and its (or their) accompanying software and/or firmware. The term “circuitry” also covers, for example and if applicable to the particular claim element, a baseband integrated circuit or processor integrated circuit for a mobile device or a similar integrated circuit in server, a cellular network device, or other computing or network device.

The features, advantages, and characteristics described herein can be combined in any suitable manner in one or more example embodiments. One skilled in the relevant art will recognize that such example embodiments can be practiced without one or more of the specific features or advantages of a particular embodiment. In other instances, additional features and advantages can be recognized in certain embodiments that may not be present in all example embodiments. One having ordinary skill in the art will readily understand that the example embodiments as discussed above may be practiced with steps in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of example embodiments.

1. A method, comprising:
determining at a user equipment that a current non-terrestrial cell belonging to a network has become unavailable to the user equipment; and
determining whether to initiate a cell search based on at least information at the user equipment about timing of availability to the user equipment of one or more other non-terrestrial cells belonging to the network.

2. The method according to claim 1, wherein determining that the current cell has become unavailable to the user equipment comprises determining that a service time has been reached after a determination at the user equipment that measurements with the user equipment of the current cell do not meet one or more cell selection criteria.

3. The method according to claim 2, comprising: in the event that the information indicates that one or more other non-terrestrial cells belonging to the network are to become available to the user equipment before a maximum waiting time after the service time, determining at the user equipment not to initiate a cell search before one or more of the one or more other cells of the non-terrestrial network becomes available according to the information at the user equipment.

4. The method according to claim 3, wherein determining whether to initiate a cell search comprises:
starting a timer in response to determining that the current cell has become unavailable to the user equipment;
determining that the information at the user equipment indicates that a non-terrestrial cell belonging to the network is not available to the user equipment before expiry of the timer; and
initiating a cell search in response to expiry of the timer.

5. The method according to claim 4, wherein the timer has a value hard-coded into the user equipment.

6. The method according to claim 4, wherein the timer has a value based on information received with the current cell.

7. The method according to claim 4, wherein the timer has a value dependent on one or more parameters of the user equipment.

8. The method according to claim 7, wherein the one or more parameters comprises one of more of: a combined uplink performance capability and downlink performance capability of the user equipment, battery settings of the user equipment, or battery condition of the user equipment.

9. The method according to claim 1, wherein the information is received at the user equipment with the current cell.

10. The method according to claim 1, wherein the information is based on measurements and calculations at the user equipment.

11. The method according to claim 10, wherein the information is based on orbital information about satellites operating non-terrestrial cells.

12. The method according to claim 1, wherein the network is a home public land mobile network for the user equipment.

13. A method, comprising: sending, to a user equipment served with a non-terrestrial cell belonging to a network, information about timing of availability to the user equipment of one or more other non-terrestrial cells belonging to the network.

14. The method according to claim 13, comprising: sending to the user equipment an indication of a maximum waiting time with which the user equipment is to initiate a cell search.

15. Apparatus, comprising:
at least one processor; and
at least one non-transitory memory storing instructions that, when executed with the at least one processor, cause the apparatus to perform:
determining at a user equipment that a current non-terrestrial cell belonging to a network has become unavailable to the user equipment;
and
determining whether to initiate a cell search based on at least information at the user equipment about timing of availability to the user equipment of one or more other non-terrestrial cells belonging to the network.

16. The apparatus according to claim 15, wherein the instructions, when executed with the at least one processor, cause the apparatus to perform determining that a service time has been reached after a determination at the user equipment that measurements with the user equipment of the current cell do not meet one or more cell selection criteria.

17. The apparatus according to claim 16, wherein the instructions, when executed with the at least one processor, cause the apparatus to perform, in the event that the information indicates that one or more other non-terrestrial cells belonging to the network are to become available to the user equipment before a maximum waiting time after the service time, determining at the user equipment not to initiate a cell search and not before one or more of the one or more other cells of the non-terrestrial network becomes available according to the information at the user equipment.

18. The apparatus according to claim 17, wherein the instructions, when executed with the at least one processor, cause the apparatus to perform:
starting a timer in response to determining that the current cell has become unavailable to the user equipment;
determining that the information at the user equipment indicates that a non-terrestrial cell belonging to the network is not available to the user equipment before expiry of the timer; and
initiating a cell search in response to expiry of the timer.

19. The apparatus according to claim 18, wherein the timer has a value hard-coded into the user equipment.

20. The apparatus according to claim 18, wherein the timer has a value based on information received with the current cell.

21. The apparatus according to claim 18, wherein the timer has a value dependent on one or more parameters of the user equipment; wherein the one or more parameters comprise one of more of: a combined uplink performance capability and downlink performance capability of the user equipment, battery settings of the user equipment, or battery condition of the user equipment.

22. The apparatus according to claim 15, wherein the information is received at the user equipment with the current cell.

23. The apparatus according to claim 15, wherein the information is based on measurements and calculations at the user equipment.

24. Apparatus, comprising:
at least one processor; and
at least one non-transitory memory storing instructions that, when executed with the at least one processor; cause the apparatus to perform:
sending, to a user equipment served with a non-terrestrial cell belonging to a network, information about timing of availability to the user equipment of one or more other non-terrestrial cells belonging to the network.

25. The apparatus according to claim 24, wherein the instructions, when executed with the at least one processor, cause the apparatus to perform sending to the user equipment an indication of a maximum waiting time with which the user equipment is to initiate a cell search.
